(19) United States
(12) Patent Application Publication
(10) Pub. No.: US 2014/0176425 A1
(43) Pub. Date: Jun. 26, 2014

(54) SYSTEM AND METHOD FOR IDENTIFYING POSITION OF HEAD-UP DISPLAY AREA

(71) Applicant: SL Corporation, Daegu (KR)

(72) Inventors: Yong Deok Bae, Gyungsan (KR); Hyun Seok Song, Gyungsan (KR); Seungyeon Jeong, Gyungsan (KR); HyunSoo Lee, Gyungsan (KR)

(73) Assignee: SL CORPORATION, Daegu (KR)

(21) Appl. No.: 14/103,284

(22) Filed: Dec. 11, 2013

(30) Foreign Application Priority Data
Dec. 20, 2012 (KR) 10-2012-00149083
Dec. 20, 2012 (KR) 10-2012-0149215

(51) Int. Cl. G02B 27/01; G06F 3/01

(52) U.S. Cl. CPC G02B 27/01; G06F 3/013
USPC 345/156

(57) ABSTRACT

A system and method for identifying the position of a head-up display (HUD) area are provided. The system in which a HUD image is displayed on a front glass of a vehicle includes a controller that is configured to determine a direction in which the HUD image moves in response to an input signal input by a driver. In addition identification information used to identify the position of the HUD area is processed according to the movement of the HUD image and the identification information is displayed on a display unit.

### CROSS-REFERENCE TO RELATED APPLICATIONS

This application claims priority from Korean Patent Applications No. 10-2012-0149083 and No. 10-2012-0149215 filed on Dec. 20, 2012, the disclosure of which is incorporated herein by reference in its entirety.

### TECHNICAL FIELD

The present invention relates to a system and method for identifying a position of a head-up display (HUD) area, and more particularly, to a system and method for identifying the position of a HUD area in which a HUD image is displayed based on a driver's eye level.

### RELATED ART

The application of cutting-edge technology to vehicles has improved the mobility and usefulness of vehicles. Thus, vehicles are becoming essential to modern society. These days, head-up displays (HUDs) are being used to project information to a driver. An HUD system enlarges information (e.g., vehicle speed, the amount of oil in the vehicle, etc.) or image information (e.g., night vision, rear surveillance images, etc.) using a lens and projects the enlarged information onto the windshield of a vehicle using a mirror. Thus, a driver recognizes the projected information while looking forward, thus, ensuring safety.

Generally, a vehicle moves approximately 55 meters for a period of time (approximately 2 seconds) during which a driver glances at the dashboard and gazes back to the road while driving at about 100 km/h, causing risks to driver safety. To reduce this risk, an apparatus for processing a HUD image has been suggested, and relevant technologies are being actively developed. The HUD system displays information (e.g., speed, driving distance, revolutions per minute (RPM), etc.) of the dashboard in a driver's main line of sight on the windshield, to allow the driver to view driving information while driving. Therefore, the driver may drive more safely by viewing important driving information without being distracted and while maintaining a forward gaze.

However, the conventional HUD system causes a negative eyebox in which the whole visual image on a HUD cannot be viewed from an arbitrary position in the vehicle. This will now be described with reference to FIGS. 1 and 2A through 2C.

FIG. 1 is an exemplary diagram illustrating a virtual HUD area 5 and an eyebox area 2 in a view from the front of a vehicle. FIGS. 2A through 2C are exemplary diagrams illustrating the virtual HUD area 5 and the eyebox area 2 according to the movement of a HUD image of FIG. 1.

Referring to FIG. 1, the virtual HUD area 5 in which the HUD image is displayed is located within the eyebox area 2. In particular, the eyebox is the position of a driver's gaze and is an area where the driver can view an image when looking forward. A height of the HUD area 5 may be adjusted within the eyebox area 2 based driver preference. However, when the height of the HUD area 5 is adjusted, a part of the HUD image may disappear depending on a driver's eye level.

In FIG. 2A, the HUD area 5 is located within the eyebox area 2. However, when the HUD area 5 in which the HUD image is displayed is moved upward as shown in FIG. 2B by manipulating a switch, a part of the HUD image which corresponds to an upper part of the HUD area 5 may disappear since the eyebox area 2 viewable by the driver is limited. In addition, when the HUD area 5 is moved downward as shown in FIG. 2C, a part of the HUD image which corresponds to a lower part of the HUD area 5 may disappear (e.g., may not be viewable to the driver). In other words, when the height of the HUD area 5 is adjusted, a part of the HUD image may disappear since the eyebox area 2 is limited based on the eye level of a driver. In particular, icons that provide various additional information to the driver are located in a lower part of the HUD image, and, for example, a refuel warning icon is not always turned on. Therefore, when the HUD area 5 is moved downward, the driver is unable to identify whether a part of the HUD image has disappeared or not.

### SUMMARY

Aspects of the present invention provide a system and method for more easily identifying the position of a head-up display (HUD) area in which a HUD image is displayed using a position recognition user interface (UI). Aspects of the present invention also provide a system and method for more easily identifying whether a part of a HUD image has disappeared when the position of a HUD area is adjusted based on an eye level of the driver. In addition, aspects of the present invention provide a system and method for identifying the position of a HUD area, in which a vehicle information image with increased transparency and the vehicle information image without transparency are displayed simultaneously on a virtual image to indirectly inform a driver about a movement direction of the virtual image.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, a system for identifying the position of a HUD area in which a HUD image is displayed on the front glass of a vehicle may include a plurality of units executed by a controller. The plurality of units may include: a direction determination unit configured to determine a direction in which the HUD image moves in response to a signal input by a driver; an information processing unit configured to process identification information used to identify the position of the HUD area according to the movement of the HUD image; and a display unit configured to display the identification information.

The information processing unit may use, as the identification information, at least one of a position recognition UI which moves according to the movement of the HUD area and an image obtained by superimposing the HUD image before being moved on the HUD image after being moved. In addition, the information processing unit may be configured to operate the position recognition UI to move according to the movement of the HUD area. When the HUD area is outside a boundary line of an eyebox area, the information processing unit may be configured to generate a signal informing that the HUD image has disappeared. When the HUD area is outside the boundary line of the eyebox area, the information processing unit may be configured to operate the position recognition UI to flicker.

The position recognition UI may further include identification UIs, which are distinguished from the position recognition UI, at both ends thereof, wherein when the HUD area is outside the boundary line of the eyebox area, the information processing unit may be configured to perform at least one of an operation of changing the shape of the identification UIs, operating the identification UIs to disappear, and operating the identification UIs to flicker. The information processing unit may be configured to adjust the transparency of the HUD image before being moved to a predetermined rate.

Further, each of the HUD image whose transparency has been adjusted to the predetermined rate and the HUD image after being moved may further include a plurality of vehicle information UIs. The vehicle information UIs may be displayed in upper and lower parts of each of the HUD images. In addition, the vehicle information UIs, the HUD image whose transparency has been adjusted to the predetermined rate, and the HUD image after being moved may be information related to the driving of the vehicle or the state of the vehicle.

The display unit may include: a display panel; a first mirror that reflects an image output from the display panel to a second mirror; the second mirror that projects the reflected image onto a windshield; and a projection angle control module that operates the movement of the second mirror. The signal input by the driver may include an angle control signal within a preset angle range. The angle control signal may include a horizontal or vertical direction to the driver.

Moreover, from a time when the signal input by the driver is received to a time after a predetermined period of time, the information processing unit may be configured to generate substantially the entire the HUD image with increased transparency and substantially the entire HUD image after being moved, regardless of the state of the vehicle. The time after the predetermined period of time may be a time when the transmission of the signal input by the driver to the information processing unit is terminated. The information processing unit may be configured to generate an image which displays information related to the state of the vehicle at the time after the predetermined period of time. The HUD image whose transparency has been adjusted to the predetermined rate may be displayed when there is a remaining angle by which the projection angle control module may move in response to the signal input by the driver.

According to another aspect of the present invention, a method of identifying the position of a HUD area in which a HUD image is displayed on the front glass of a vehicle may include: receiving, by a controller, a signal from a driver; determining, by the controller, a direction in which the HUD image moves in response to the received signal; processing, by the controller, identification information used to identify the position of the HUD area according to the movement of the HUD image; and displaying, by the controller, the identification information for the driver.

The processing of the identification information may include operating a position recognition UI to move in response to the movement of the HUD area according to the movement of the HUD image. The processing of the identification information may include generating an image by superimposing the HUD image before being moved on the HUD image after being moved.

According to another aspect of the present invention, a method of identifying the position of a HUD area in which a HUD image is displayed on the front glass of a vehicle may include: receiving, by a controller, a signal from a driver; moving, by the controller, the HUD area within an eyebox area; and moving, by the controller, a position recognition UI in response to the movement of the HUD area.

### BRIEF DESCRIPTION OF THE DRAWINGS

The above and other aspects and features of the present invention will become more apparent by describing in detail exemplary embodiments thereof with reference to the attached drawings, in which:

FIG. 1 is an exemplary diagram illustrating a virtual head-up display (HUD) area and an eyebox area in a view from the front of a vehicle according to the prior art;

FIGS. 2A through 2C are exemplary diagrams illustrating the virtual HUD area and the eyebox area according to the movement of a HUD image of FIG. 1 according to the prior art;

FIG. 3 is an exemplary block diagram illustrating the configuration of a system for identifying the position of a HUD area according to an exemplary embodiment of the present invention;

FIG. 4 is an exemplary conceptual diagram illustrating the configuration of the system for identifying the position of the HUD area according to the exemplary embodiment of FIG. 3;

FIG. 5 is an exemplary diagram illustrating a position recognition user interface (UI), which indicates the position of the HUD area, in the position identification system of FIG. 3 according to an exemplary embodiment of the present invention;

FIG. 6A is an exemplary diagram illustrating the movement of the position recognition UI according to the movement of a HUD image of FIG. 5 according to an exemplary embodiment of the present invention;

FIG. 6B is an exemplary diagram illustrating the loss of a lower part of the HUD image due to the downward movement of the HUD image of FIG. 5 according to an exemplary embodiment of the present invention;

FIG. 7 is an exemplary diagram illustrating a plurality of position recognition UIs, which indicate the position of the HUD area, in the position identification system of FIG. 3 according to an exemplary embodiment of the present invention;

FIG. 8A is an exemplary diagram illustrating the movement of a vertical position recognition UI according to the vertical movement of the HUD image of FIG. 6 according to an exemplary embodiment of the present invention;

FIG. 8B is an exemplary diagram illustrating the movement of a horizontal position recognition UI according to the horizontal movement of the HUD image of FIG. 6 according to an exemplary embodiment of the present invention;

FIGS. 9 through 12 are exemplary diagrams illustrating operation characteristics of superimposed images, which show the position of the HUD area, in the position identification system of FIG. 3 according to an exemplary embodiment of the present invention;

FIG. 13 is an exemplary view of a display panel and a backlight unit of a display unit according to an exemplary embodiment of the present invention;

FIG. 14 is an exemplary flowchart illustrating a method of identifying the position of a HUD area according to an exemplary embodiment of the present invention;

FIG. 15 is an exemplary flowchart illustrating a method of identifying the position of a HUD area according to another exemplary embodiment of the present invention; and

FIG. 16 is an exemplary flowchart illustrating a method of identifying the position of a HUD area according to another exemplary embodiment of the present invention.

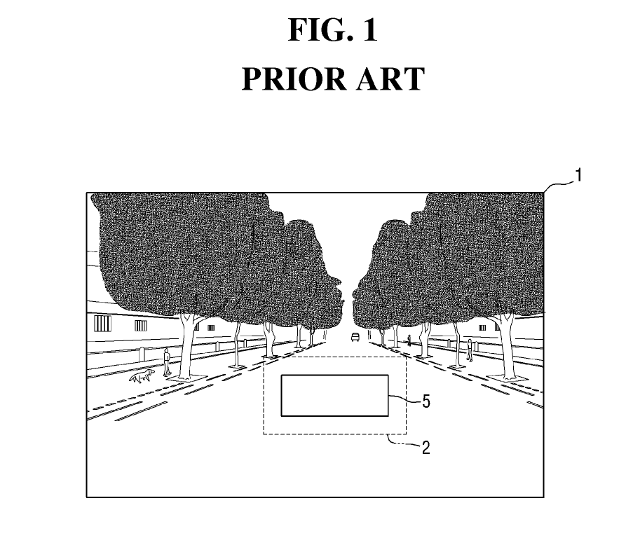

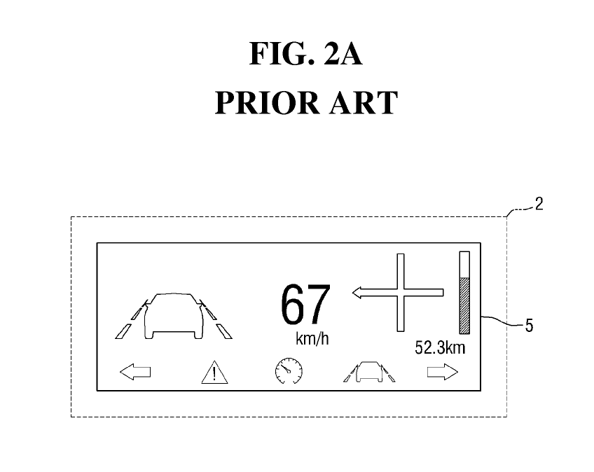

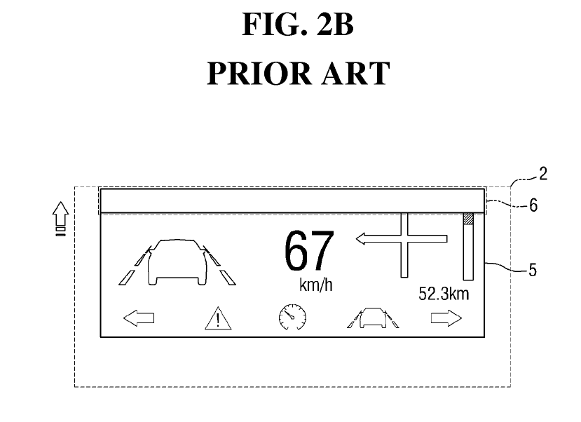

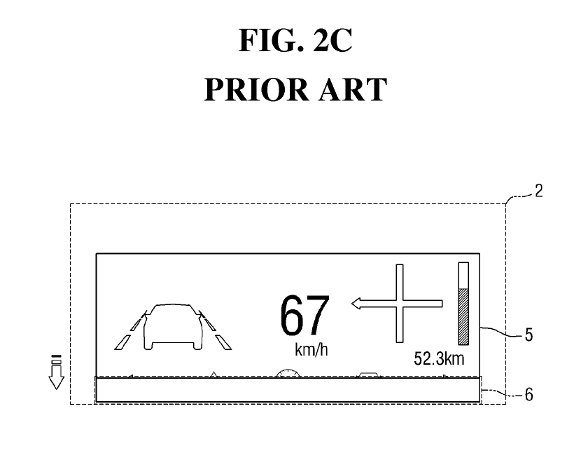

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the present invention.

Hereinafter, the present invention will be described in more detail with reference to the attached drawings.

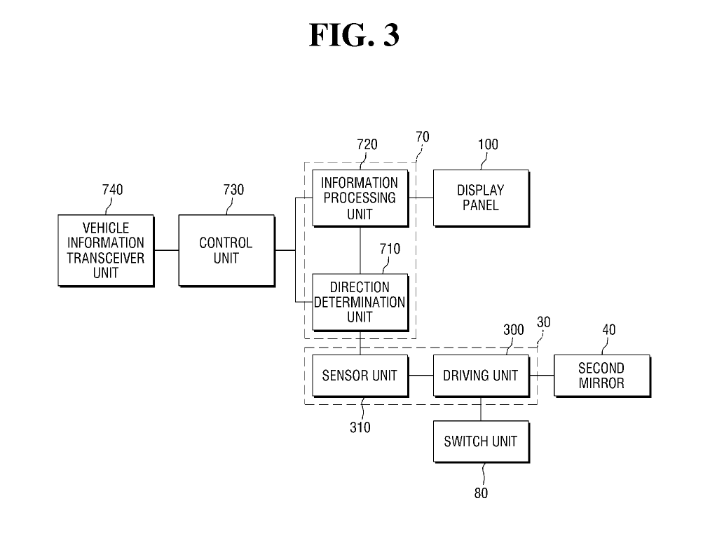

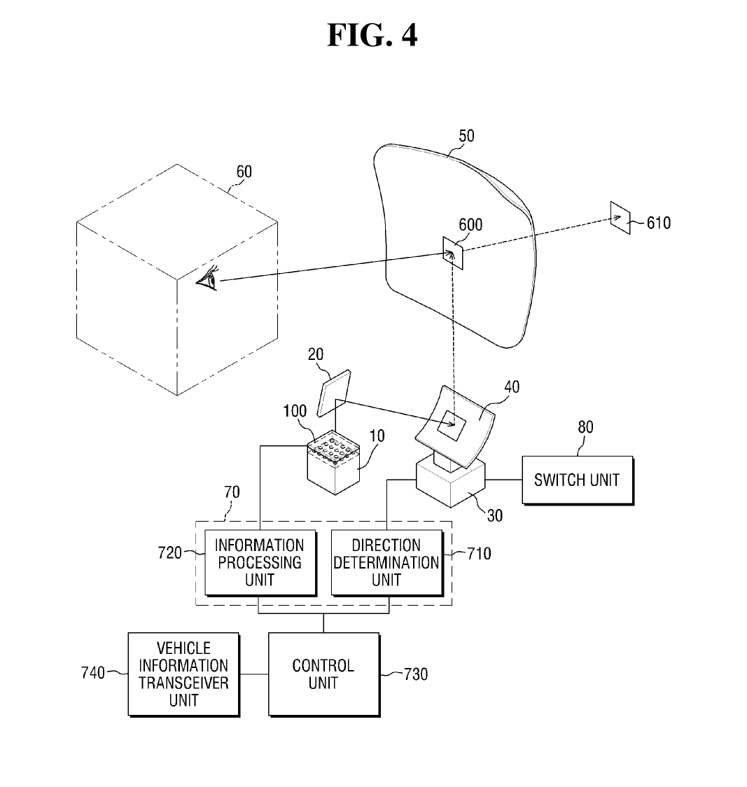

FIG. 3 is an exemplary block diagram illustrating the configuration of a system for identifying the position of a head-up display (HUD) area according to an exemplary embodiment of the present invention. FIG. 4 is an exemplary conceptual diagram illustrating the configuration of the system for identifying the position of the HUD area according to the exemplary embodiment of FIG. 3.

Referring to FIGS. 3 and 4, the system for identifying the position of the HUD area may include a backlight unit 10, a display panel 100, a first mirror 20, a second mirror 40, a projection angle controller 30, a switch unit 80, and an information processor 70. In addition, the system for identifying the position of the HUD area may be connected to a controller 730 (e.g., a first controller) and a vehicle information transceiver 740 which may be connected to the controller 730. The system for identifying the position of the HUD area may be used to identify the position of the HUD area in which a HUD image is displayed on the front glass of a vehicle.

In the system for identifying the position of the HUD area, a direction determination unit 710, executed by the controller 730, may be configured to determine a direction in which the HUD image moves in response to a signal input by a driver. Further, an information processing unit 720, executed by the controller 730, may be configured to process identification information used to identify the position of the HUD area according to the movement of the HUD image and may be configured to display the processed identification information on a display unit, to allow the driver to identify the position of the HUD area in which the HUD image is displayed. In particular, the identification information may include information needed for the driver to identify the position of the HUD area. Examples of the identification information may include a position recognition user interface (UI) which moves according to the movement of the HUD area and an image obtained by superimposing the HUD image before being moved on the HUD image after being moved.

The information processor 70 may include the information processing unit 720 and the direction determination unit 710 and may be executed by the controller 730. The information processing unit 720 may be connected to the display panel 100 and may be configured to transmit an electrical signal regarding processed information to the display panel 100. For example, the information processing unit 720 may be configured to identify the position of the HUD area using at least one of the position recognition UI which moves according to the movement of the HUD area and the image obtained by superimposing the HUD image before being moved on the HUD image after being moved as the identification information. The direction determination unit 710 may be connected to a sensor 310 and a driving unit 300 included in the projection angle controller 30 (e.g. a second controller). The driving unit 300 may be connected to the switch unit 80. In addition, the driving unit 300 may be connected to the second mirror 40 to adjust an angle of the second mirror 40. The controller 730 may be connected to the vehicle information transceiver unit 740 that transmits or receives vehicle information and exchange certain electrical signals with the vehicle information transceiver unit 740. The sensor 310 may be, but is not limited to, a hall sensor.

The controller 700 may be configured to receive a signal regarding the vehicle including the information processor 70 and send a specific instruction or perform a specific operation based on the received signal. In the exemplary embodiment of the present invention, the controller 700 may be connected to the information processing unit 720, the direction determination unit 710, and the vehicle information transceiver unit 740 of the information processor 70.

The second mirror 40 may be configured to project an image of vehicle driving information onto a windshield 50. The second mirror 40 may be, but is not limited to, a mirror that has a predetermined curvature and reflects light. The windshield 50 may generally refer to the front glass or front window of a vehicle. In other words, the windshield 50 may refer to the glass formed at the front of a vehicle. The windshield 50 may be formed of a transparent body to secure the driver's view and may be equipped with wipers for removing snow and rain.

The driving unit 300 may be included in the projection angle controller 30. When the driver inputs an angle adjustment signal via the switch 80, the driving unit 300 may be configured to adjust the angle of the second mirror 40 in response to the angle adjustment signal. By adjusting the angle of the second mirror 40, the driving unit 300 may be configured to adjust the position of a HUD image 610 which is a virtual image viewable by the driver. An image of vehicle information viewed by the driver is not a real image 600 but the virtual HUD image 610. In addition, the image may be viewed by the driver may not have a frame around it. In the exemplary embodiment of the present specification, the frame may be provided around the image for ease of description. However, the present invention is not limited thereto, and the frame may be displayed around the virtual HUD image 610.

By operating the driving unit 300 using the switch 80, it may be possible to adjust both a vertical angle θy and a horizontal angle θx of the projection angle controller 30. In particular, θy may denote an angle in a vertical direction, i.e., a direction perpendicular to the ground when the driver views the windshield 50 in the driver's seat, and θx may denote an angle in a horizontal direction to the ground. By adjusting the angle of the projection angle controller 30 using the switch 80, it may also be possible to move the HUD image 610 in upward, downward, right and left directions.

The driver may adjust θy or θx within a preset angle range. Assuming that an angle when the HUD image 610 is located in the substantially center of an eyebox area 60 is about zero degrees, the preset angle range may be set to a range of about ±2 to ±3 degrees from the zero degrees in the vertical or horizontal direction. However, the preset angle is a concept encompassing all angle ranges that may be generally expected by those of ordinary skill in the art when configuring an image processing apparatus.

The eyebox area 60 may be the position of the driver's gaze and may be a virtual area. In other words, the eyebox area 60 may be an area where the driver may view the HUD image 610 when looking forward. When the HUD image 610 is beyond the boundaries of the eyebox area 60, the image is not viewable by the driver (e.g., the image disappears). In other words, the eyebox area 60 may be an area where the HUD image 610 may be displayed. The eyebox area 60 may be a relative concept that is not fixed but varies according to the driver's field of view. Generally, the driver may view the HUD image 610 when the driver's field of view is within the eyebox area 60. Thus, when the driver's field of view is beyond the eyebox area 60, the virtual HUD image 610 may disappear or appear blurred.

The sensor 310 included in the projection angle controller 30 together with the driving unit 300 may be configured to obtain information regarding the current angle of the second mirror 40 based on, for example, a rotation angle of the driving unit 300 and transmit the obtained information to the direction determination unit 710. The sensor 310 may be configured to obtain the information regarding the current angle using any method (of obtaining direction or angle information using a sensor) that may be expected by those of ordinary skill in the art.

The direction determination unit 710 included in the information processor 70 may be connected to the driving unit 300. The direction determination unit 710 may be configured to receive the current angle of the second mirror 40 from the sensor 310. In addition, the direction determination unit 710 may be configured to calculate a difference value between an angle input to the switch 80 by the driver and the current angle of the projection angle controller 30 and transmit the difference value to the controller 730. Then, the controller 730 may be configured to transmit the difference value to the information processing unit 720 to increase the transparency of the HUD image 610 disposed at the current angle and display the HUD image 610, which may be disposed at an angle away from the current angle by the difference value, at an original transparency before being increased. An image having increased transparency may be expressed as an image having positive transparency, and an opaque image or UI may be expressed as an image that has been moved. A relevant exemplary embodiment will be described later.

The vehicle information transceiver unit 740 may include all signals regarding the use, maintenance and management of the vehicle which may be expected by those of ordinary skill in the art, such as vehicle signals regarding situations that may occur when the vehicle is driven or stopped. The vehicle information transceiver unit 740 may be configured to receive the above signals and transmit the received signals to the controller 730. Then, the controller 730 may be configured to generate an electrical signal including information to be displayed on the display panel 100 and transmit the electrical signal to the display panel 100. The electrical signal may also be transmitted to the display panel 100 via the vehicle information transceiver unit 740, and the present invention is not limited by the above exemplary embodiment.

A vehicle information image displayed on the display panel 100 may be projected onto the first mirror 20 and then reflected to the second mirror 40. The first mirror 20 may be, but is not limited to, a flat mirror. The reflected image may be reflected again by the second mirror 40 to the windshield 50 and thus projected onto the windshield 50. In particular, the real image 600 may be formed on the windshield 50 but may not be viewed by the driver. An image viewed by the driver at the driver's position may be a virtual image, that is, the virtual HUD image 610 on a rear surface of the windshield 50. Through the above process, the driver may view current information about the vehicle. Each of the first mirror 20 and the second mirror 40 may include at least one mirror. The first mirror 20 and the second mirror 40 may be used to prevent distortion of an image due to different curvatures of the windshield 50 in different parts of the windshield 50.

The projection angle controller 30 may be configured to adjust the angle of the second mirror 40 to an angle, at which the HUD image 610 is viewable, according to an eye level of a driver. As described above, the angle of the projection controller 30 may be adjusted by the driving unit 300 included in the projection angle controller 30, and information regarding a current angle and an angle desired by the driver may be sensed by the sensor 310 and transmitted to the direction determination unit 710. Thus, the position of the HUD image 610 may be adjusted based on the angle of the projection angle controller 30.

Exemplary embodiments of processing identification information used to identify the position of the HUD area will now be described.

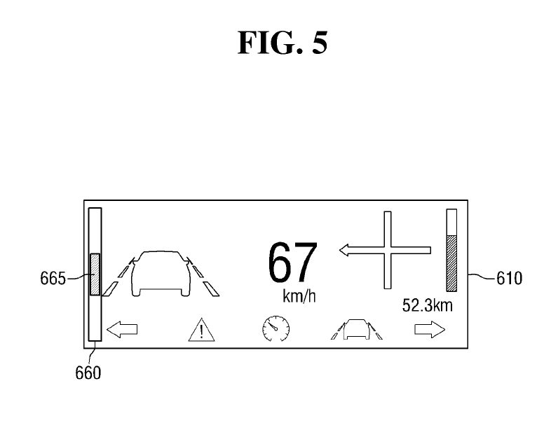

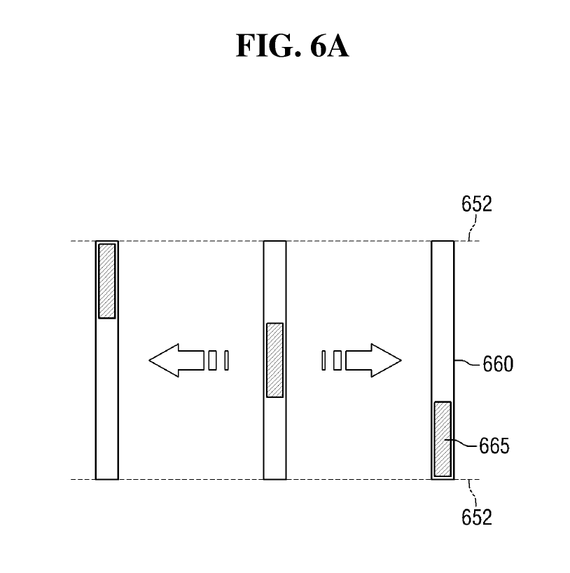

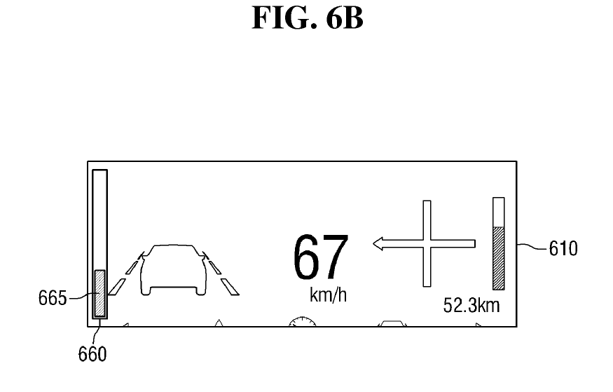

FIG. 5 is an exemplary diagram illustrating a position recognition UI 665, which indicates the position of the HUD area, in the position identification system of FIG. 3. FIG. 6A is an exemplary diagram illustrating the movement of the position recognition UI 665 according to the movement of the HUD image 610 of FIG. 5. FIG. 6B is an exemplary diagram illustrating the loss of a lower part of the HUD image 610 due to the downward movement of the HUD image 610 of FIG. 5.

As described above, the information processing unit 720 may be configured to process identification information used to identify the position of the HUD area according to the movement of the HUD image 610. For example, the information processing unit 720 may be configured to operate the position recognition UI 665 to move at the same time as the movement of the HUD area. In particular, the position recognition UI 665 may be a UI displayed to enable the driver to identify whether a part of the HUD image 610 has disappeared. A scroll bar may be used as an example of the position recognition UI 665.

The position recognition UI 665 may move at the same time as the vertical movement of the HUD area in which the HUD image 610 is displayed. However, it will be obvious to those of ordinary skill in the art that the present invention is not limited thereto. A height of a UI display area 660 within which the position recognition UI 665 moves may be, but is not limited to, equal to a height of the eyebox area 60. When the HUD area is located in about the middle of the eyebox area 60 as shown in FIG. 5, the HUD image 610 may be within the eyebox area 60. Thus, the position recognition UI 665 may be in about the middle of the UI display area 660. When the HUD area is moved up or down (e.g., vertically) according to the driver's eye level as shown in FIG. 6A, the position recognition UI 665 may also move up or down. Therefore, the driver may determine the HUD area according to an eye level without losing a part of the HUD image 610 by checking the movement of the position recognition UI 665.

For example, referring to FIG. 6B, when the eye level of the driver is substantially low (e.g., below a threshold), the HUD area may be moved downward. In particular, when the position recognition UI 665 reaches a bottommost end of the UI display area 660, the lower part of the HUD image 610 disappears. Thus, when the HUD area reaches a topmost or bottommost end of the eyebox area 60, a signal that informs a user of the disappearance of the HUD image 610 may be displayed. The signal may be any signal that informs the user, e.g., visually or audibly. For example, when the HUD area moves out of a boundary line of the eyebox area 60, the information processing unit 720 may be configured to operate the position recognition UI 665 to flicker or generate a warning signal. The height of the eyebox area 60 may be displayed proportional to the height of the UI display area 660, to allow the user to view the HUD when the HUD area reaches the topmost or bottommost end of the eyebox area 60.

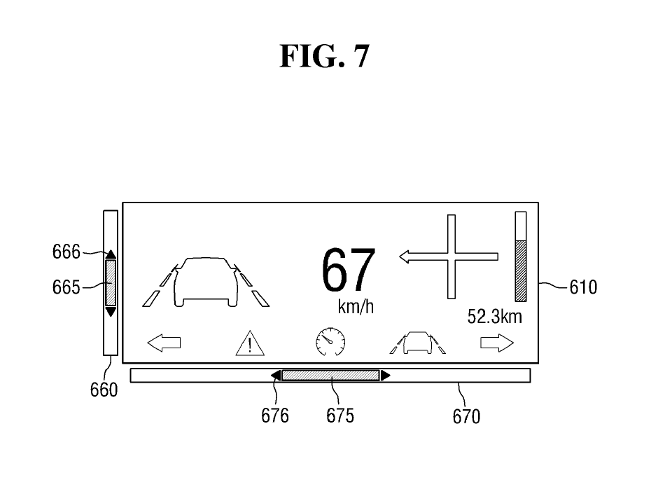

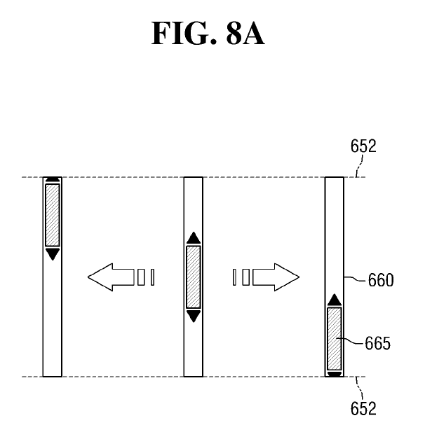

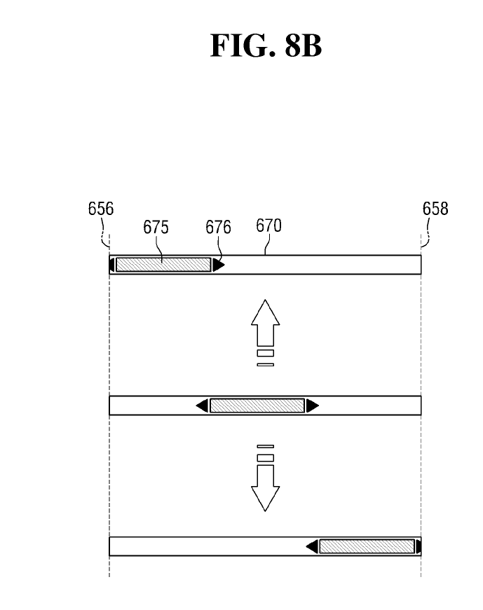

FIG. 7 is an exemplary diagram illustrating a plurality of position recognition UIs, which indicate the position of the HUD area, in the position identification system of FIG. 3. FIG. 8A is an exemplary diagram illustrating the movement of a vertical position recognition UI 665 according to the vertical movement of the HUD image 610 of FIG. 6. FIG. 8B is an exemplary diagram illustrating the movement of a horizontal position recognition UI 675 according to the horizontal movement of the HUD image 610 of FIG. 6.

Referring to FIG. 7, to identify the position of the HUD area in which the HUD image 610 is displayed on the front glass of a vehicle, the vertical position recognition UI 665 or the horizontal position recognition UI 675 may be moved according to the movement of the HUD area within the eyebox area 60. Each of the vertical position recognition UI 665 and the horizontal position recognition UI 675 may further include identification UIs 666 or 676 at both ends thereof, and the identification UIs 666 or 676 may be distinguished from the vertical position recognition UI 665 or the horizontal position recognition UI 675. When the HUD area moves out of the boundary line of the eyebox area 60, the information processing unit 720 may be configured to perform at least one of an operation of changing the shape of the identification UIs 666 or 676, operating the identification UIs 666 or 676 to disappear, and operating the identification UIs 666 or 676 to flicker.

The HUD area may be affected by the eyebox area 60 based on the eye level of a driver. However, since the position of the HUD area may need to be adjusted vertically and horizontally, the vertical position recognition UI 665 and/or the horizontal position recognition UI 675 may be displayed together to display the position of the HUD area more accurately. The identification UIs 666 at both ends of the vertical position recognition UI 665 and the identification UIs 676 at both ends of the horizontal position recognition UI 675 may inform the user when the HUD area moves out of the boundary line of the eyebox area 60.

In an example, when part of the HUD area is beyond a topmost end 652 of the eyebox area 60 as shown in FIG. 8A, part of the upper identification UI (e.g., an upper triangular shape) among the identification UIs 666 at both ends of the vertical position recognition UI 665 may disappear. In addition, when part of the HUD area is beyond a bottommost end 654 of the eyebox area 60, part of the lower identification UI (e.g., a lower triangular shape) among the identification UIs 666 at both ends of the vertical position recognition UI 665 may disappear.

In another example, when part of the HUD area is beyond a leftmost end 656 of the eyebox area 60 as shown in FIG. 8B, part of the left identification UI (e.g., a left triangular shape) among the identification UIs 676 at both ends of the horizontal position recognition UI 675 may disappear. In addition, when part of the HUD area is beyond a rightmost end 658 of the eyebox area 60, part of the right identification UI (e.g., a right triangular shape) among the identification UIs 676 at both ends of the horizontal position recognition UI 675 may disappear. Further, when part of the HUD area is beyond the boundary line of the eyebox area 60, the identification UIs 666 and 676 may flicker, or the shape of the identification UIs 666 and 676 may change. The user may also determine in other various ways whether part of the HUD area has moved beyond the boundary line of the eyebox area 60.

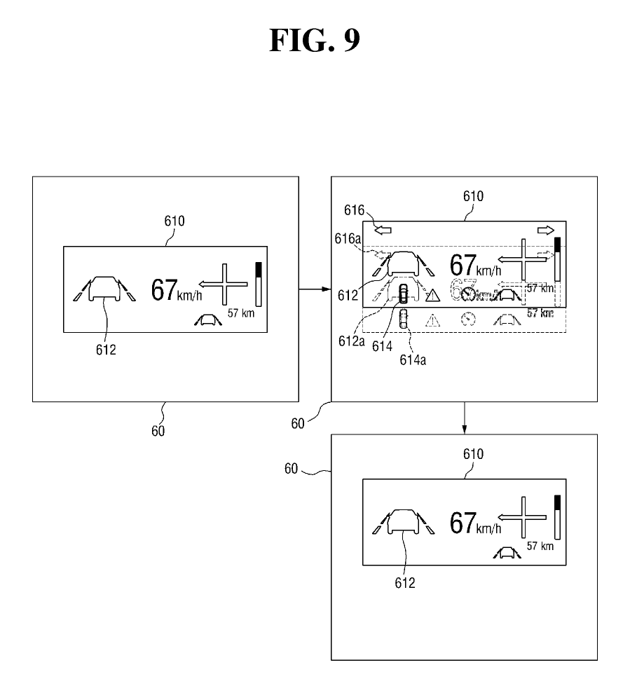

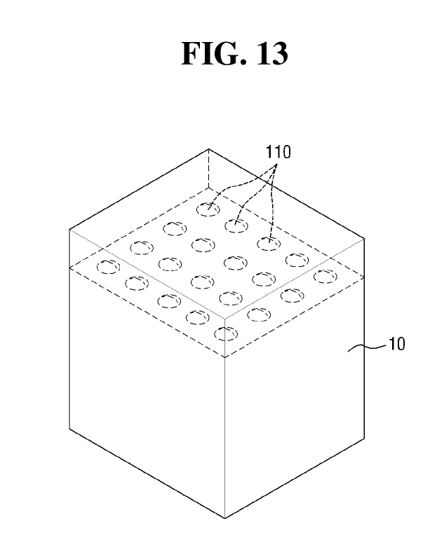

FIGS. 9 through 12 are exemplary diagrams illustrating operation characteristics of superimposed images, which show the position of the HUD area, in the position identification system of FIG. 3. FIG. 13 is an exemplary view of the display panel 100 and the backlight unit 10 of the display unit according to an exemplary embodiment of the present invention.

As described above, the information processing unit 720 may be configured to process identification information used to identify the position of the HUD area according to the movement of the HUD image 610. For example, the information processing unit 720 may be configured to generate an image by superimposing the HUD image 610 before being moved on the HUD image 610 after being moved and display the generated image to allow a driver to identify whether a part of the HUD image 610 has disappeared. In particular, the information processing unit 720 may be configured to adjust the transparency of the HUD image 610 before being moved to a predetermined rate. Each of the HUD image 610 whose transparency has been adjusted to the predetermined rate and the HUD image 610 after being moved may further include a plurality of vehicle information UIs. The vehicle information UIs may be configured to display all information regarding the driving of a vehicle and the state of the vehicle. The vehicle information UIs may be displayed in upper and lower parts of each image, but the present invention is not limited thereto. In addition to the vehicle information UIs, the HUD image 610 whose transparency has been adjusted to the predetermined rate and the HUD image 610 after being moved may serve as information related to the driving of the vehicle or the state of the vehicle.

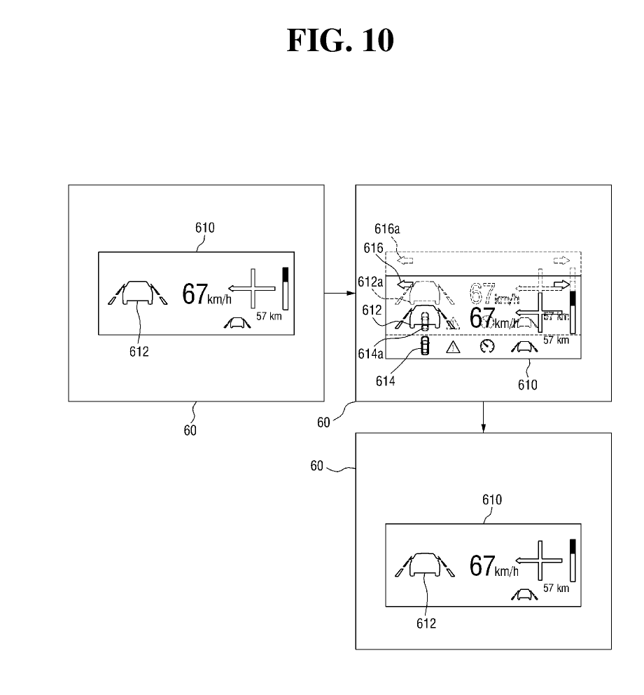

Referring to FIGS. 9 and 10, when a driver does not manipulate the switch 80 for a period of time, an opaque vehicle information image 612 may be displayed. Assuming that a median value of transparency is about zero, the HUD image 610 may have a transparency of about zero (i.e., the median value) when the system for identifying the position of the HUD area is turned on. However, the transparency of the HUD image 610 may also have a positive value. In addition, the transparency of the HUD image 610 may be adjusted to a positive value or a negative value. Particularly, adjusting transparency to a positive value may be to increase transparency, and adjusting transparency to a negative value may be to reduce transparency. An opaque image may be defined as an image having a transparency of about zero for ease of description, and transparency may be adjusted by the driver. The above example of transparency is merely an exemplary embodiment, and the present invention is not limited to this embodiment. When necessary, an opaque upper UI 616 and an opaque lower UI 614 may be displayed to show the occurrence of a certain situation. However, when the driver does not manipulate the switch 80 of the vehicle, UIs may not always be displayed. In other words, the UIs may not be displayed when situations indicated by the UIs do not occur.

As described above, the opaque vehicle information image 612 may be displayed before the driver manipulates the switch 80. When a switch manipulation signal input by the driver is transmitted from the switch 80 to the controller 730, that is, when the driver manipulates the switch 80 to adjust the position of the HUD image 610, the controller 730 may be configured to instruct the information processing unit 720 to increase the transparency of the virtual HUD image 610, which is located at a position before the driver manipulates the switch 80, to a predetermined rate. The predetermined rate may be a preset value, and the driver may arbitrarily adjust the transparency. The predetermined rate may have a positive value, that is, the transparency may be increased. However, the predetermined rate may also have a negative value. In some cases, the transparency may not be adjusted.

From a time when a signal input by the driver is received to a time after a predetermined period of time, the information processing unit 720 may be configured to generate the whole of an image having increased transparency and the whole of an image after being moved, regardless of the state of the vehicle. In other words, while the driver is manipulating the switch 80 to move the position of the HUD image 610, a vehicle information image 612a having increased transparency and the opaque virtual image 612 may be displayed together. Since the vehicle information image 612a that has increased transparency and the opaque virtual image 612 may be displayed together, the driver may recognize a direction in which the HUD image 610 has been moved. In particular, the time after the predetermined period of time may be a time when the transmission of the signal input by the user to the information processing unit 720 is terminated.

When the HUD image 610 is located at a boundary line (i.e., at a preset threshold or range) of the eyebox area 60, that is, when a part of the HUD image 610 is about to move out of the eyebox area 60, the HUD image 610 may not be moved, and images 612a, 614a and 616a having increased transparency may not be displayed. However, the present invention is not limited thereto. The images 612a, 614a and 616a having increased transparency may be displayed from a time when the driver starts to manipulate the switch 80 to a time when the driver stops manipulating the switch 80. However, this is merely an exemplary embodiment, and the images 612a, 614a and 616a having increased transparency may be displayed for a predetermined period of time after the time when the driver stops manipulating the switch 80.

When necessary, the opaque upper and lower UIs 614 and 616 and the UIs 614a and 616a having greater transparency than the opaque upper and lower UIs 614 and 616 may be displayed together. In addition, the vehicle information image 612a having increased transparency and the UIs 614a and 616a having increased transparency may be continuously displayed on the HUD image 610 while the driver manipulates the switch 80. When the driver stops manipulating the switch 80, the HUD image 610 may move to a position desired by the driver, and the vehicle information image 612a having increased transparency and the UIs 614a and 616a having increased transparency may disappear. The UIs 614, 616, 614a and 616a may be provided in a plurality and may be located in lower and upper parts of the HUD image 610.

While the driver manipulates the switch 80, both the lower and upper UIs 614 and 616, which were expected to be displayed in the HUD image 610, may be displayed. In addition, while the driver manipulates the switch 80, the lower and upper UIs 614a and 616a having greater transparency than the lower and upper UIs 614 and 616 may be displayed. Both the lower and upper UIs 614 and 616 produced when the driver manipulates the switch 80 may be displayed regardless of the current state of the vehicle. Accordingly, the driver of the vehicle may recognize the area of the HUD image 610 and prevent the HUD image 610 from moving upward or downward beyond the eyebox area 60 to disappear or look blurred.

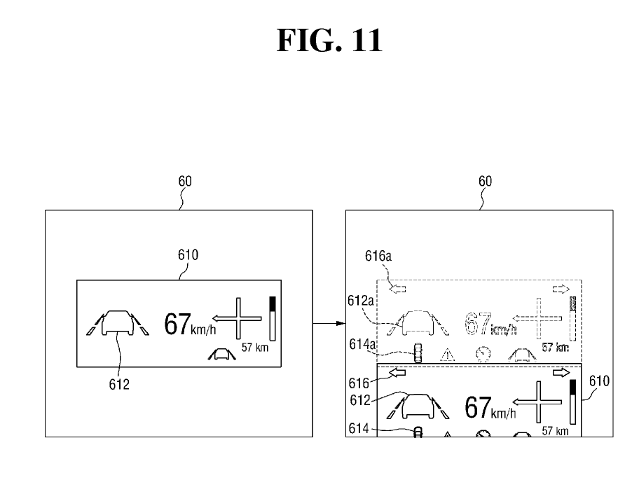

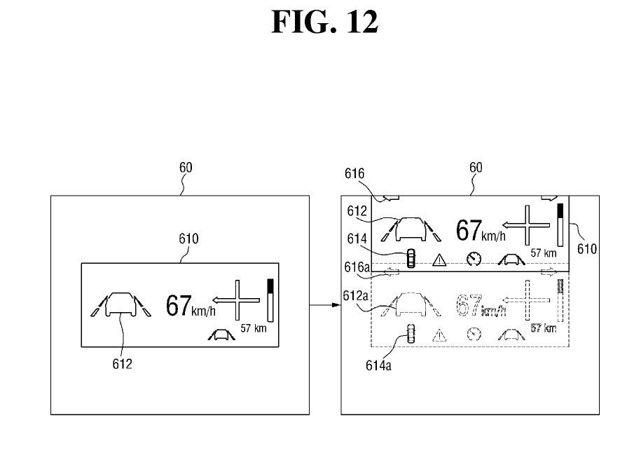

In FIGS. 11 and 12, exemplary embodiments in which the HUD image 610 moves downward and upward beyond the eyebox area 60 are illustrated. When the driver of the vehicle manipulates the switch 80 to move the position of the HUD image 610, the HUD image 610 may move beyond the eyebox area 60 to disappear or look blurred.

As described above, when the driver manipulates the switch 80, all of the UIs 614 and 616 may be displayed regardless of whether they are displayed on the HUD image 610. The UIs 614 and 616 may be considered as information relatively less important than the vehicle information image 612 needed by the driver. Since all of the UIs 614 and 616 may be displayed when the driver manipulates the switch 80, the driver may recognize that the HUD image 610 is beyond the eyebox area 60 when all of the UIs 614 and 616 disappear. Through this operation, it may be possible to prevent the disappearance of the vehicle information image 612 in advance. In addition, since substantially the entire HUD image 610 may be displayed, the range of the HUD image 610 may be recognized by the driver.

The projection angle controller 30 may be manipulated within a predetermined angle range, and the eyebox area 60 may be included within the angle range. In addition, the image and the UIs 612a, 614a and 616a having increased transparency may be displayed when there is a remaining angle by which the projection angle controller 30 may be moved in response to a signal input by the driver. In other words, when the HUD image 610 is located at a maximum or minimum value among angle values preset in the projection angle controller 30, when the driver manipulates the switch 80 to move the HUD image 610 to a position having an angle value greater than the maximum value or a position having an angle value smaller than the minimum value, the image and the UIs 612a, 614a and 616a having increased transparency may not be displayed, and the HUD image 610 may not be moved. When the HUD image 610 is located at the maximum value or the minimum value among the angle values preset in the projection angle controller 30, the maximum value or the minimum value may correspond to any one range or edge among the ranges or edges of the HUD image 610. However, the present invention is not limited thereto. Accordingly, the driver may determine that the HUD image 610 may no longer be moved vertically or horizontally from the current position of the HUD image 610.

The above exemplary embodiments may apply to when the HUD image 610 is moved upward or downward and when the HUD image 610 is moved to the left or the right.

To provide various pieces of identification information to the driver, the backlight unit 10 may include a plurality of semiconductor point light sources 110 as shown in FIG. 13. The display panel 100 may be disposed on a top of the backlight unit 10 and may be used to display vehicle information. The display panel 100 may use a liquid crystal display (LCD). Otherwise, the display panel 100 may use any display that may be used in an image processing apparatus 90 and expected by those of ordinary skill in the art, such as an organic light-emitting diode (OLED), an active matrix organic light-emitting diode (AMOLED), a plasma display panel (PDP), or a field emitter display (FED).

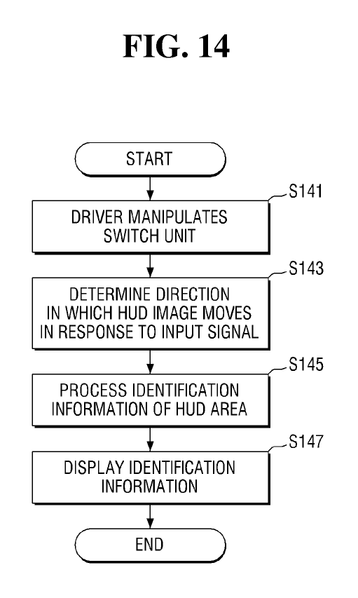

FIG. 14 is an exemplary flowchart illustrating a method of identifying the position of a HUD area according to an exemplary embodiment of the present invention. Referring to FIG. 14, the method of identifying the position of the HUD area includes processing identification information to identify the position of the HUD area in which a HUD image may be displayed on the front glass of a vehicle.

Specifically, when a signal is input (operation S141), a direction in which a HUD image 610 moves in response to the input signal may be determined by a controller (operation S143). Then, identification information used to identify the position of a HUD area according to the movement of the HUD image 610 may be processed (operation S145), and the identification information may be displayed, by the controller, to the driver.

In processing the identification information (operation S145), a position recognition UI 665 may be moved in response to the movement of the HUD area according to the movement of the HUD image 610, or an image obtained by superimposing the HUD image 610 before being moved on the HUD image 610 after being moved may be generated and provided to the driver.

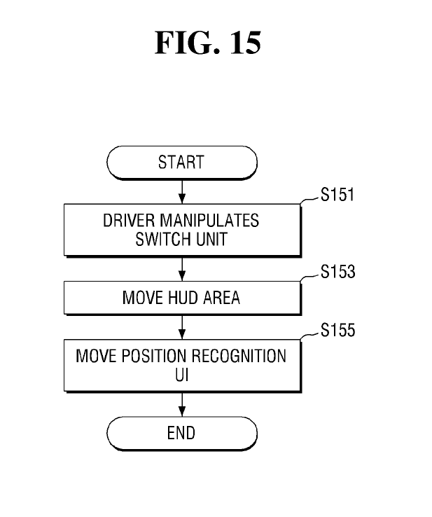

FIG. 15 is an exemplary flowchart illustrating a method of identifying the position of a HUD area according to another exemplary embodiment of the present invention. Referring to FIG. 15, in the method of identifying the position of the HUD area, when a signal is input (operation S151), a direction in which a HUD image 610 moves in response to the input signal may be determined by a controller (operation S153). Accordingly, a position recognition UI 665 may be moved, allowing the driver to recognize the movement of a HUD area. The position recognition UI 665 may be displayed, by the controller, to enable the driver to identify the HUD area and whether the HUD image 610 has disappeared. As described above, a scroll bar may be used as an example of the position recognition UI 665. However, it is obvious to those of ordinary skill in the art that the position recognition UI 665 is not limited to the scroll bar.

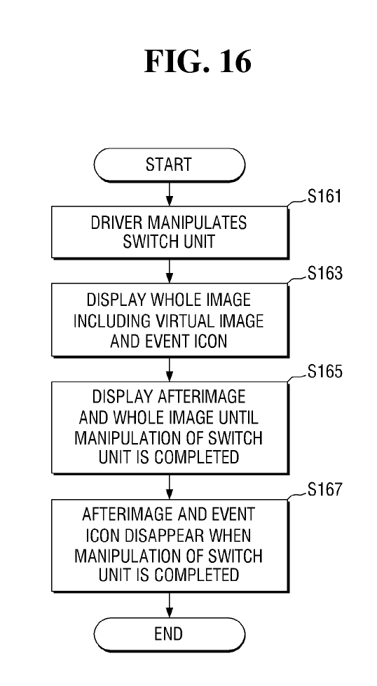

FIG. 16 is an exemplary flowchart illustrating a method of identifying the position of a HUD area according to another exemplary embodiment of the present invention.

Referring to FIG. 16, an opaque vehicle information image 612 may be displayed before a driver manipulates a switch 80. When necessary, an upper or lower UI 616 or 614 may be displayed. When the switch 80 is manipulated (operation S161), the upper and lower UIs 616 and 614 may be displayed together with the opaque vehicle information image 612, regardless of whether an event related to the upper and lower UIs 616 and 614 has occurred (operation S163). Until the driver stops manipulating the switch 80 and until a HUD image 610 is moved to a desired position, a vehicle information image 612a having increased transparency and all of the upper and lower UIs 616a and 614a having increased transparency may be displayed (operation S165). In particular, the images 612a, 614a and 616a having increased transparency may remain at original positions before the driver manipulates the switch 80. In other words, the images 612a, 614a and 616a may not be moved by the manipulation of the switch 80 by the driver. When the driver completes the manipulation of the switch 80, the images 612a, 614a and 616a having increased transparency may disappear, and all of the UIs 614 and 616 displayed regardless of the current state of the vehicle may also disappear. Instead, the opaque vehicle information image 612 and a UI related to the current driving state of the vehicle may be displayed (operation S167). That is, a state before the driver manipulates the switch 80 may be restored.

In another example, the method of identifying the position of the HUD area may be implemented as an information processing method which includes receiving, by a controller, a signal from a driver, determining, by the controller, a direction in which a HUD image moves in response to the received signal, generating, by the controller, an image by superimposing the HUD image before being moved on the HUD image after being moved, and outputting, by the controller, the generated image to the driver.

According to the present invention, the position of a HUD area in which a HUD image is displayed may be identified using identification information such as a position recognition UI or an image obtained by superimposing the HUD image before being moved on the HUD image after being moved. In addition, when the position of the HUD area is adjusted based on an eye level of a driver, the shape of an arrow included in a scroll bar may change or disappear. Therefore, the driver may identify that a part of the HUD image has disappeared more easily. Further, a vehicle information image with increased transparency and the vehicle information image without transparency may be displayed simultaneously on a virtual image to indirectly inform the driver of the vehicle about a movement direction of the virtual image.

A method of identifying the position of a HUD area according to an exemplary embodiment of the present invention may be implemented as one module by software and hardware. The above-described exemplary embodiments of the present invention may be written as computer programs and may be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium may also be distributed over network coupled computer systems to store and execute the computer readable code in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A system for identifying the position of a head-up display (HUD) area in which a HUD image is displayed on a front glass of a vehicle, the system comprising:
a memory of a controller configured to store program instructions; and
a processor of the controller configured to execute the program instructions, the program instructions when executed configured to:
determine a direction in which the HUD image moves in response to an input signal;
process identification information used to identify the position of the HUD area according to the movement of the HUD image; and
display the identification information via a display unit.

2. The system of claim 1, wherein the identification information is selected from a group consisting of at least one of: a position recognition user interface (UI) that moves according to the movement of the HUD area and an image obtained by superimposing the HUD image before being moved on the HUD image after being moved.

3. The system of claim 2, wherein the program instructions when executed are further configured to operate the position recognition UI to move according to the movement of the HUD area.

4. The system of claim 2, wherein the program instructions when executed are further configured to generate a signal informing that the HUD image has disappeared when the HUD area is beyond a boundary line of an eyebox area.

5. The system of claim 4, wherein the program instructions when executed are further configured to operate the position recognition UI to flicker when the HUD area is beyond the boundary line of the eyebox area.

6. The system of claim 4, wherein the position recognition UI further includes:
a plurality of identification UIs, distinguished from the position recognition UI, at both ends thereof,
wherein the program instructions when executed are further configured to perform at least one of an operation of changing the shape of the identification UIs, operating the identification UIs to disappear, and operating the identification UIs to flicker when the HUD area is beyond the boundary line of the eyebox area.

7. The system of claim 2, wherein the program instructions when executed are further configured to adjust the transparency of the HUD image before being moved to a predetermined rate.

8. The system of claim 7, wherein each of the HUD image whose transparency has been adjusted to the predetermined rate and the HUD image after being moved further includes a plurality of vehicle information UIs, wherein the vehicle information UIs are displayed in upper and lower parts of each of the HUD images.

9. The system of claim 8, wherein the vehicle information UIs, the HUD image whose transparency has been adjusted to the predetermined rate, and the HUD image after being moved are information related to the driving of the vehicle or the state of the vehicle.

10. The system of claim 1, wherein the display unit includes:
a display panel;
a first mirror that reflects an image output from the display panel to a second mirror, wherein the second mirror projecting the reflected image onto a windshield; and
a projection angle controller configured to operate the movement of the second mirror.

11. The system of claim 1, wherein the input signal includes an angle control signal within a preset angle range.

12. The system of claim 11, wherein the angle control signal includes a horizontal or vertical direction to the driver.

13. The system of claim 8, wherein from a time when the input signal is received to a time after a predetermined period of time, the program instructions when executed are further configured to generate an entire HUD image with increased transparency and an entire HUD image after being moved, regardless of the state of the vehicle.

14. The system of claim 13, wherein the time after the predetermined period of time is a time when the transmission of the input signal is terminated.

15. The system of claim 13, wherein the program instructions when executed are further configured to generate an image that displays information related to the state of the vehicle at the time after the predetermined period of time.

16. The system of claim 7, wherein the HUD image whose transparency has been adjusted to the predetermined rate is displayed when there is a remaining angle by which the projection angle controller can move in response to the input signal.

17. A method of identifying the position of a head-up display (HUD) area in which a HUD image is displayed on a front glass of a vehicle, the method comprising:
receiving, by a controller, a signal from a driver;
determining, by the controller, a direction in which the HUD image moves in response to the received signal;
processing, by the controller, identification information used to identify the position of the HUD area according to the movement of the HUD image; and
displaying, by the controller, the identification information to the driver.

18. The method of claim 17, wherein the processing of the identification information includes:
operating, by the controller, a position recognition user interface (UI) to move in response to the movement of the HUD area according to the movement of the HUD image.

19. The method of claim 17, wherein the processing of the identification information includes:
generating, by the controller, an image by superimposing the HUD image before being moved on the HUD image after being moved.

20. A method of identifying the position of a head-up display (HUD) area in which a HUD image is displayed on a front glass of a vehicle, the method comprising:
receiving, by a controller, a signal from a driver;
moving, by the controller, the HUD area within an eyebox area; and
moving, by the controller, a position recognition user interface (UI) in response to the movement of the HUD area.

21. A non-transitory computer readable medium containing program instructions executed by a controller, the computer readable medium comprising:
program instructions that receive a signal from a driver;
program instructions that determine a direction in which the HUD image moves in response to the received signal;
program instructions that process identification information used to identify the position of the HUD area according to the movement of the HUD image; and
program instructions that display the identification information to the driver.

22. The non-transitory computer readable medium of claim 21, further comprising:
program instructions that operate a position recognition user interface (UI) to move in response to the movement of the HUD area according to the movement of the HUD image.

23. The non-transitory computer readable medium of claim 21, further comprising:
program instructions that generate an image by superimposing the HUD image before being moved on the HUD image after being moved.
